(19) United States
(12) Patent Application Publication
(10) Pub. No.: US 2012/0221884 A1
(43) Pub. Date: Aug. 30, 2012

(54) ERROR MANAGEMENT ACROSS HARDWARE AND SOFTWARE LAYERS

(76) Inventors: Nicholas P. Carter, Hillsboro, OR (US); Donald S. Gardner, Mountain View, CA (US); Eric C. Hannah, Pebble Beach, CA (US); Helia Naeimi, Santa Clara, CA (US); Shekhar Y. Borkar, Beaverton, OR (US); Matthew Haycock, Beaverton, OR (US)

(21) Appl. No.: 13/036,826

(22) Filed: Feb. 28, 2011

(51) Int. Cl. G06F 11/07

(52) U.S. Cl. 714/2; 714/E11.023

(57) ABSTRACT

Generally, this disclosure provides error management across hardware and software layers to enable hardware and software to deliver reliable operation in the face of errors and hardware variation due to aging, manufacturing tolerances, etc. In one embodiment, an error management module is provided that gathers information from the hardware and software layers, and detects and diagnoses errors. A hardware or software recovery technique may be selected to provide efficient operation, and, in some embodiments, the hardware device may be reconfigured to prevent future errors and to permit the hardware device to operate despite a permanent error.

### FIELD

The present disclosure relates to error management of hardware and software layers, and, more particularly, to collaborated, cross-layer error management of hardware and software applications.

### BACKGROUND

As the feature sizes of fabrication processes shrink, rates of errors, device variation, and device aging are increasing, forcing systems to abandon the assumption that circuits will work as expected and remain constant over the life of a computer system. Current reliability techniques are very hardware-centric, which may simplify software design, but are typically energy intensive and often sacrifice efficiency and bandwidth. To the extent that applications are written with error detection and recovery capabilities, the application approach may be insufficient, and may even clash with hardware reliability approaches. Thus, current hardware-only or software-only reliability techniques do not respond adequately to errors, especially as error rates increase due to aging, device variation, and environmental factors.

### BRIEF DESCRIPTION OF DRAWINGS

Features and advantages of the claimed subject matter will be apparent from the following detailed description of embodiments consistent therewith, which description should be considered with reference to the accompanying drawings, wherein:

FIG. 1 illustrates a system consistent with various embodiments of the present disclosure;

FIG. 2 illustrates a method for determining system information consistent with one embodiment of the present disclosure;

FIG. 3 illustrates a method for detecting and diagnosing hardware errors consistent with one embodiment of the present disclosure;

FIG. 4 illustrates a method for error recovery operations consistent with one embodiment of the present disclosure;

FIG. 5 illustrates a method for hardware device reconfiguration and system adaptation consistent with one embodiment of the present disclosure; and

FIG. 6 illustrates a method for cross-layer error management of a hardware device and at least one application running on the hardware device consistent with one embodiment of the present disclosure.

Although the following Detailed Description will proceed with reference being made to illustrative embodiments, many alternatives, modifications, and variations thereof will be apparent to those skilled in the art.

### DETAILED DESCRIPTION

Generally, this disclosure provides systems (and methods) to enable hardware and software to collaborate to deliver reliable operation in the face of errors and hardware variation due to aging, manufacturing tolerances, environmental conditions, etc. In one system example, an error management module provides error detection, diagnosis, recovery and hardware reconfiguration and adaptation. The error management module is configured to communicate with a hardware layer to obtain information about the state of the hardware (e.g., error conditions, known defects, etc.), error handling capabilities, and/or other hardware parameters, and to control various operating parameters of the hardware. Similarly, the error management module is configured to communicate with at least one software application layer to obtain information about the application's reliability requirements (if any), error handling capabilities, and/or other software parameters related to error resolution, and to control error handling of the application(s). With knowledge of the various capabilities and/or limitations of the hardware layer and the application layer, in addition to other system parameters, the error management module is configured to make decisions about how errors should be handled, which hardware error handling capabilities should be activated at any given time, and how to configure the hardware to resolve recurring errors.

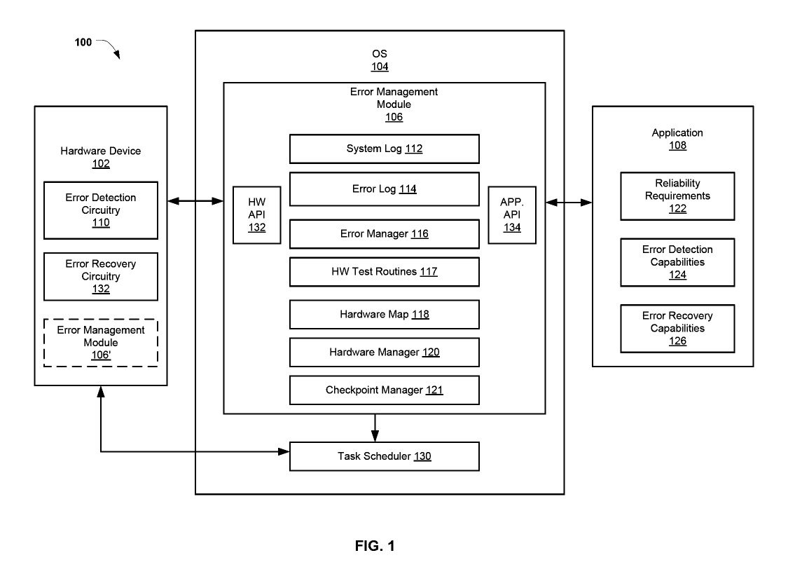

FIG. 1 illustrates a system consistent with various embodiments of the present disclosure. In general, the system 100 of FIG. 1 includes a hardware device 102, an operating system (OS) 104, an error management module 106, and at least one application 108. As will be described in greater detail below, the error management module 106 is configured to provide cross-layer resilience and reliability of the hardware device 102 and the application 108 to manage errors. The hardware device 102 may include any type of circuitry that is configured to exchange commands and data with the OS 104, the error management module 106 and/or the application 108. For example, the hardware device 102 may include commodity circuitry (e.g., a multi-core CPU (which may include a plurality of processing cores and arithmetic logic units (ALUs)), memory, memory controller unit, video processor, network processor, network processor, bus controller, etc.) that is found in a general-purpose computing system (e.g., desktop PC, laptop, mobile PC, handheld mobile device, smart phone, etc.) and/or custom circuitry as may be found in a general-purpose computing system and/or a special-purpose computing system (e.g. highly reliable system, supercomputing system, etc.).

The hardware device 102 may also include error detection circuitry 110. In general, the error detection circuitry 110 includes any type of known or after-developed circuitry that is configured to detect errors associated with the hardware device 102. Examples of error detection circuitry 110 include memory ECC codes, parity/residue codes on computational units (e.g., CPUs, etc.), Cyclic Redundancy Codes (CRC), circuitry to detect timing errors (RAZOR, error-detecting sequential circuitry, etc.), circuitry that detects electrical behavior indicative of an error (such as current spikes during a time when the circuitry should be idle) checksum codes, built-in self-test (BIST), redundant computation (in time, space, or both), path predictors (circuits that observe the way programs proceed through instructions and signal potential errors if a program proceeds in an unusual manner), “watchdog” timers that signal when a module has been unresponsive for too long a time, and bounds checking circuits.

The hardware device 102 may also include error recovery circuitry 132. In general, the error recovery circuitry 132 includes any type of known or after-developed circuitry that is configured to recovery from errors associated with the hardware device 102. Examples or hardware-based error recovery circuitry include redundant computation with voting (in time, space, or both), error-correction codes, automatic re-issuing of instructions, and rollback to a hardware-saved program state.

While the error detection circuitry 110 and the error recovery circuitry 132 may be separate circuits, in some embodiments the error handling circuitry 110 and the error recovery circuitry 132 may include combined circuits that operate, at least in part, to both detect errors and to recover from errors. “Circuitry”, as used in any embodiment herein, may comprise, for example, singly or in any combination, hardwired circuitry, programmable circuitry, state machine circuitry, and/or firmware that stores instructions executed by programmable circuitry.

The application 108 may include any type of software package, code module, firmware and/or instruction set that is configured to exchange commands and data with the hardware device 102, the OS 104 and/or the error management module 106. For example, the application 108 may include a software package associated with a general-purpose computing system (e.g., end-user general purpose applications (e.g., Microsoft Word, Excel, etc.), network applications (e.g., web browser applications, email applications, etc.)) and/or custom software package, custom code module, custom firmware and/or custom instruction set (e.g., scientific computational package, database package, etc.) written for a general-purpose computing system and/or a special-purpose computing system.

The application 108 may be configured to specify reliability requirements 122. The reliability requirements 122 may include, for example, a set of error tolerances that may be allowable by the application 108. By way of example, and assuming that the application 108 is a video application, the reliability requirements 122 may specify certain errors as critical errors that cannot be ignored without significant impact on the performance and/or function of the application 108, and other errors may be designated as non-critical errors that may be ignored completely (or ignored until the number of such errors exceeds a predetermined error rate). Continuing this example, a critical error for such an application may include an error in the calculation of a starting point of a new video frame, while pixel rendering errors may be deemed non-critical errors (which may be ignored if below a predetermined error rate). Another example of reliability requirements 122 include, in the context of a financial application, the specification that the application may ignore any errors that do not cause the final result to change by at least one cent. Still another example of reliability requirements 122 include, in the context of an application that performs iterative refinement of solutions, the specification that the application may tolerate certain errors in intermediate steps, as such errors may only cause the application to require more iterations to generate the correct result. Some applications, such as internet searches, have multiple correct results, and can ignore errors that do not prevent them from finding one of the correct results. Of course, these are only examples of reliability requirements 122 that may be associated with the application 108.

The application 108 may also include error detection capabilities 124. The error detection capabilities 124 may include, for example, one or more instruction sets that enable the application 108 to detect certain errors that occur during execution of all or part of the application 108. An example of application-based error detection capabilities 124 includes self-checking code that enables the application 106 to observe the result of an operation and determine if that result is correct (given, for example, the operands and instructions of the operation). Other examples of application-based error detection capabilities 124 include code that monitors application-specified invariants (e.g., variable X should always be between 1 and 100, variable Y should always be less than variable X, only one of a sequence of comparisons should be true, etc.), self-checking code (a class of computations called nondeterministic polynomial (NP)-complete are known to be able to check the correctness of their results in much less time than it takes to generate the results); similarly, there are known techniques such as application-based fault tolerant (ABFT) for adding self-checking to mathematical computations on matrices, etc., application-based checksums or other error-detecting codes, application-directed redundant execution, etc.

The application 108 may also include error recovery capabilities 126. The error recovery capabilities 126 may include, for example, one or more instruction sets that enable the application 108 to recover from certain errors that occur during execution of all or part of the application 108. Examples of application-based error recovery capabilities 126 may include computations that can be re-executed until they complete correctly (idempotent computations), application-based checkpointing and rollback, application-based error-correction codes (e.g., ECC codes), redundant execution, etc.

The term “error”, as used herein, means any type of unexpected response from the hardware device 102 and/or the application 108. For example, errors associated with the hardware device 102 may include logic/circuitry faults, single-event upsets, timing violations due to aging, etc. Errors associated with the application 108 may include, for example, control-flow errors (such as branches taking the wrong path), operand errors, instruction errors, etc. Of course, while certain applications may include error detection capabilities, error recovery capabilities and/or the ability to specify reliability requirements, there exists classes of “legacy” software applications that do not include at least one of these capabilities/abilities. Thus, and in other embodiments, the application 106 may be a legacy application that does not include one or more of error detection capabilities 124, error recovery capabilities 126 and/or the ability to specify reliability needs 122.

The OS 104 may include any general purpose or custom operating system. For example, the OS 104 may be implemented using Microsoft Windows, HP-UX, Linux, or UNIX, and/or other general purpose operating system. The OS 104 may include a task scheduler 130 that is configured to assign the hardware device 102 (or part thereof) to at least one application 108 and/or one or more threads associated with one or more applications. The task scheduler 130 may be configured to make such assignments based on, for example, load distribution, usage requirements of the hardware device 102, processing and/or capacity of the hardware device 102, application requirements, state information of the hardware device 102, etc. For example, if hardware device 102 is a multi-core CPU and the system 100 includes a plurality of applications requesting service from the CPU, the task scheduler 130 may be configured to assign each application to a unique core so that the load is distributed across the CPU. In addition, the OS 104 may be configured to specify predefined and/or user power management parameters. For example, if system 100 is a battery powered device (e.g., laptop, handheld device, PDA, etc.) the OS 104 may specify a power budget for the hardware device 102, which may include, for example, a maximum allowable power draw associated with the hardware device 102. In addition, OS power management may allow a user to provide guidance about whether they would prefer maximum performance or maximum battery life, while some applications have performance (quality of service) requirements (e.g., video players need to process 60 frames/second, VOIP needs to keep up with spoken data rates, etc.). Such user inputs and/or application requirements may be included with task scheduling as well. In addition, priority factors may be included with task scheduling. An example of a priority factor, in the context of a computing system in a car, includes an assignment of high priority to responding to a crash and of low priority to the radio. In addition, hardware state information may factor into task scheduling. For example, the number of cores available to applications might be decreased as the temperature of the integrated circuit increases, in order to keep the integrated circuit from overheating.

The error management module 106 is configured to exchange commands and/or data with the hardware device 102, the application 108 and/or the OS 104. The module 106 is configured to determine the capabilities of the hardware device 102 and/or the application 108, detect errors occurring in the hardware device 102 and/or the application 108, and attempt to diagnose those errors, recover from those errors and/or reconfigure the hardware to enable the system to, for example, adapt to permanent hardware faults, tolerate performance changes such as aging, etc. In addition, the module 106 is configured to select an error recovery mechanism that is suited to overall system parameters (e.g., power management) to enable the hardware 102 and/or the application 108 to recover from certain errors. The module 106 is further configured to reconfigure the hardware device 102 (e.g., by varying hardware operating points and/or disabling sections of the hardware device that are no longer functional) to resolve errors and/or avoid future errors. In addition, with additional system parameters (e.g., power budget, etc.), the module 106 is configured to configure the hardware device 102 based on those system parameters. The module 106 may be further configured to communicate with the OS 104 to obtain, for example, OS power management parameters that may specify certain power budgets for the hardware device 102 and/or usage requirements of the hardware device 102 (as may be specified by an application 108).

The error management module 106 may include a system log 112. The system log 112 is a log file that includes information, gathered by the error management module 106, regarding the hardware device 102, the application 108 and/or the OS 104. In particular, the system log 112 may include information related to error detection and/or error handling capabilities of the hardware device 102, information related to the reliability requirements and/or error detection and/or error handling capabilities of the application 108, and/or system information such as power management budgets, application priorities, application performance requirements (e.g., quality of service), etc. (as may be provided by the OS 104 and as described above). The structure of the system log 112 may be, for example, a look-up table (LUT), data file, etc.

The error management module 106 may also include an error log 114. The error log 114 is a log file that includes, for example, information related to the nature and frequency of errors detected by the hardware device 102 and/or the application 108. Thus, for example, when an error occurs on the hardware device 102, the error management module 106 may poll the hardware device 102 to determine the type of error that has occurred (e.g., a logic error (e.g., miscomputed value), timing error (right result, but too late), data retention error (wrong value returned from a memory or register)). In addition, the error management module 106 may determine the severity of the error (e.g., the more wrong bits that were generated, the worse the error, particularly for data retention errors). As errors are detected by the module 106, the error type and/or severity may be logged into the error log 114. In addition, the location of the error in the hardware device 102 may be determined and logged into the system log 114. For example, if the hardware device 102 is a multi-core CPU, the error may be in an ALU on one of the cores, the cache memory of a core, etc. In addition, the time of the error occurrence (e.g., time stamp) and the number of the same type of error that have occurred may be logged into the error log 114. Additionally, the error log 114 may include designated error recovery mechanisms that have resolved previous errors of the same or similar type. For example, if a previous error was resolved using a selected error recovery capabilities 126 of the application 108, such information may be logged in the error log 114 for future reference. The structure of the error log 114 may be, for example, a look-up table (LUT), data file, etc.

The error management module 106 may also include an error manager 116. The error manager 116 is a set of instructions configured to manage errors that occur in the system 100, as described herein. Error management includes gathering information of the capabilities and/or limitations of the hardware device 102 and the application 108, and gathering system resource information (e.g., power budget, bandwidth requirements, etc) from the OS 104. In addition, error management includes detecting errors that occur in the hardware device 102 (or that occur in the application 108) and diagnosing those errors to determine if recovery is possible or if the hardware device can be reconfigured to resolve the error and/or prevent future errors. Each of these operations is described in greater detail below.

The error management module 106 may also include a hardware map 118. The hardware map 118 is a log of the capabilities (such as known permanent faults) and the current and permissible range of operating points of the hardware device 102. Operating points may include, for example, permissible values of supply voltage and/or clock rate of the hardware device 102. Other examples of operating points of the hardware device 102 include temperature/clock rate pairs (e.g., core X can run at 3.5 GHz if below 80 C, 3.0 GHz if above). If the operating points and/or capabilities of the hardware device 102 change as a result of reconfiguration techniques (described below), the new operating points of the hardware device 102 may also be logged in the hardware map 118. The structure of the hardware map 118 may be, for example, a look-up table (LUT), data file, etc.

The error management module 106 may also include hardware test routines 117. The hardware test routines 117 may include a set of instructions, utilized by the error management module 106 during recovery operations (described below)), to cause the hardware device 102 to perform tests at multiple operating points. Here, the “tests” may include routines designed to exercise different portions of the hardware (ALUs, memories, etc.), routines known to produce worst-case delays in logic paths (e.g., additions that exercise all of the carry chain in an adder), routines known to consume the maximum possible power, routines that test communication between different hardware units, routines that test rare “corner” cases in the hardware, routines that test the error detection circuitry 110 and/or error recovery circuitry 132, etc. The hardware test routines 117 may also be invoked periodically even if the hardware has not detected any errors in order to detect faults and/or to determine if aging is likely to produce timing faults in the near future and/or to determine if changes in environment (temperature, supply voltage, etc.) allow the hardware to operate at operating points that caused errors in the past.

The error management module 106 may also include a hardware manager 120. The hardware manager 120 includes a set of instructions to enable the error management module to communicate with, and control the operation of, at least in part, the hardware device 102. Thus, for example, when diagnosing errors and directing error recovery or reconfiguration (each described below), the hardware manager 120 may provide instructions to the hardware device 102 (as may be specified by the error manager 116).

The error management module 106 may also include a checkpoint manager 121. The checkpoint manager 121 may monitor the application 108 at runtime and save state information at various times and/or instruction branches. The checkpoint manager 121 may enable the application 108 to roll back to a selected point, e.g., to a point before an error occurs. In operation, the checkpoint manager 121 may periodically save the state of the application 108 in some storage (thus generating a “known good” snapshot of the application) and, in the event of an error, the checkpoint manager 121 may load a checkpointed state of the application 108 so that the application 108 can re-run the part of the application that sustained the error. This may enable, for example, the application 108 to continue running even though an error has occurred and is being diagnosed by the error management module 106.

The error management module 106 may also include programming interfaces 132 and 134 to enable communication between the hardware device 102 and the error management module 106, and the application 108 and the error management module 106. Each programming interface 132 and 134 may include, for example, an application programming interface (API) that includes a specification that defines a set of functions or routines that may be called or run between the two entities the hardware device 102 and the module 106, and between the application 108 and the module 106.

It should be noted that although FIG. 1 depicts a single application 108, in other embodiments more than one application may be requesting service from the hardware device 102, and each such application may include similar features as those described above for application 108. For example, if the hardware device 102 is a multi-core CPU, a plurality of applications may be running on the CPU, and the error management module 106 may be configured to provide error management, consistent with the description herein, for each application running on the hardware device 102. Similarly, although FIG. 1 depicts a single hardware device 102, in other embodiments more than one hardware device may be servicing an application 108, and each such hardware device may include similar features as those described above for hardware device 102. For example, if the hardware device 102 is a multi-core CPU, each core of the CPU may be considered an individual hardware device, and the collection of such cores (or some subset thereof) may host the application 108 and/or one or more threads of the application 108. In any case, the error management module 106 may be configured to provide error management, consistent with the description herein, for each hardware device in the system 100.

The error management module 106 may be embodied as a software package, code module, firmware and/or instruction set that performs the operations described herein. In one example, and as depicted in FIG. 1, the error management module 106 may be included as part of the OS 104. To that end, the error management module 106 may be embodied as a software kernel that integrates with the OS 104 and/or a device driver (such as a device driver that is included with the hardware device 102). In other embodiments, the error management module 106 may be embodied as a stand-alone software and/or firmware module that is configured in a manner consistent with the description provided herein. In still other embodiments, the error management module 106 may include a plurality of distributed modules in communication with each other and with other components of the system 100 via, for example, a network (e.g., intranet, internet, LAN, WAN, etc.). In still other embodiments, the error management module may be embodied as circuitry of the hardware device 102, as depicted by the dashed-line box 106′ of FIG. 1, and the operations described with reference to the error management module 106 may be equally implemented in circuitry, as in error management module 106′. In still other embodiments, the components of the error management module may be distributed between the hardware device 102 and the software-based module 106. In such an embodiment, for example, the test routines (117) may be embodied as circuitry on the hardware device 102, while the remaining components of the module 106 may be embodied as software and/or firmware.

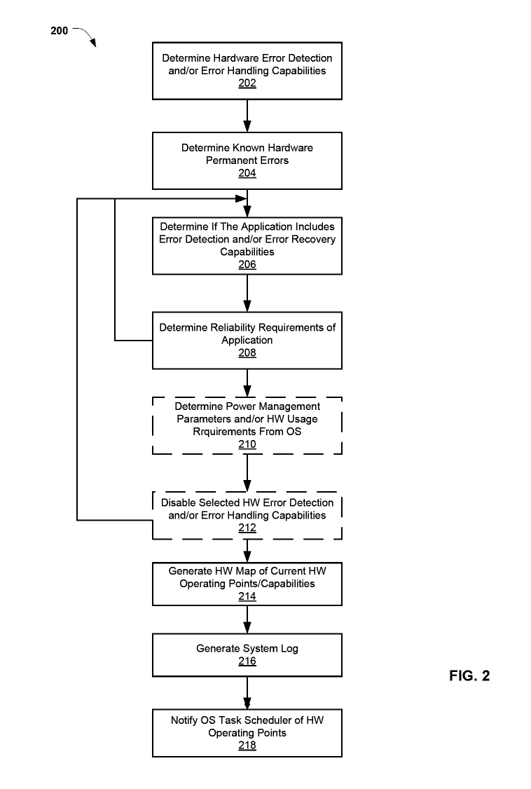

The operations of the error management module 106 according to various embodiments of the present disclosure are described below with reference to FIGS. 2, 3, 4, 5 and 6.

### Determining System Information

FIG. 2 illustrates a method 200 for determining system information consistent with one embodiment of the present disclosure. In particular, the method 200 of this embodiment determines information about the hardware device, the application and/or the operating system, so that the error management module has information to enable effective error management decisions given cross-layer information about the hardware device, the application and/or the operating system. With continued reference to FIG. 1, and with reference numbers of FIG. 1 omitted for clarity, operations of the method 200 may include determining hardware error detection capabilities and/or error recovery capabilities 202. In one embodiment, the error management module may poll the hardware device to determine which, if any, hardware capabilities are available. In another embodiment, for example if the error management module is in the form of a device driver, this information may be supplied by the hardware manufacturer and/or third party vendor and included with the error management module. The error management module may also determine known hardware permanent errors 204. Permanent errors may include, for example, one or more faulty core(s)/ALU(s), faulty buffer memory, faulty memory location(s) and/or other faulty sections of the hardware device that renders at least part of the hardware device inoperable.

Operations may also include determining if the application includes error detection and/or error recovery capabilities 206. In addition, operations may include determining the reliability requirements of the application 208. In one embodiment, the error management module may poll the application to determine which, if any, application capabilities and/or requirements are available. In another embodiment, for example as an application comes “on-line” by requesting service from the hardware device via the operating system, the error management module may receive a message from the operating system indicating that an application is requesting service from the hardware device, and the OS may prompt the error management module to poll the application to determine capabilities and/or requirements, or the application may forward the application's capabilities and/or requirements to the OS.

In addition, the error management module may be configured to determine power management parameters and/or hardware usage requirements, as may be specified by, for example, the OS 210. Power management parameters may include, for example, allowable power budgets for the hardware device (which may be based on battery vs. wall-socket power). Based on information of the hardware device, application and power management parameters, operations may also include disabling selected hardware error detection and/or error handling capabilities 212. For example, a given error detection technique may require less power and less bandwidth when run in the application verses hardware. Thus, the error management module may disable selected hardware error detection capabilities to save power and/or provide more efficient operation. As another example, if the application reliability requirements indicate that certain errors are non-critical, the error management module may disable selected hardware error detection capabilities designed to detect those non-critical errors, which may translate into significant reduction of hardware operating overhead in the event such non-critical errors occur.

Operations may also include generating a hardware map of current hardware operating points and known capabilities 214. As noted above, the operating points of the hardware device may include valid voltage/clock frequency pairs (e.g., Vdd/clock) that are permitted for operation of the hardware device. Known capabilities may include known errors and/or known faults associated with the hardware device. In one embodiment, the error management module may poll the hardware device to determine which, if any, operating points are available for the hardware device and which, if any, known faults are associated with the hardware device and/or subsections of the hardware device. In another embodiment, for example if the error management module is in the form of a device driver, this information, at least in part, may be supplied by the hardware manufacturer and/or third party vendor and included with the error management module.

Operations may also include generating a system log 216. As stated above, the system log 112 may include information related to error detection and/or error handling capabilities of the hardware device 102, information related to the reliability requirements and/or error detection and/or error handling capabilities of the application 108, and/or system information (as may be provided by the OS 104). The error management module may also be configured to notify the OS task scheduler of hardware operating points/capabilities 218. This may enable the task scheduler to efficiently schedule hardware tasks based on known operating points and/or capabilities of the hardware. Thus, for example, if an ALU of the hardware device is faulty (but the remaining cores/ALUs are working properly), notifying the OS task scheduler of this information may enable the OS task scheduler to make effective decisions about which applications/threads should not be assigned to the core with the defective ALU (e.g., computationally intensive applications/threads).

In a typical system, applications may be launched and closed in a dynamic manner over time. Thus, in some embodiments, as an additional application is launched and requests service (i.e., exchange of commands and/or data) from the hardware device, operations 206, 208, 210, 212, 214, 216 and/or 218 may be repeated so that the error management module maintains a current state-of-the-system awareness.

### Error Detection and Diagnosis

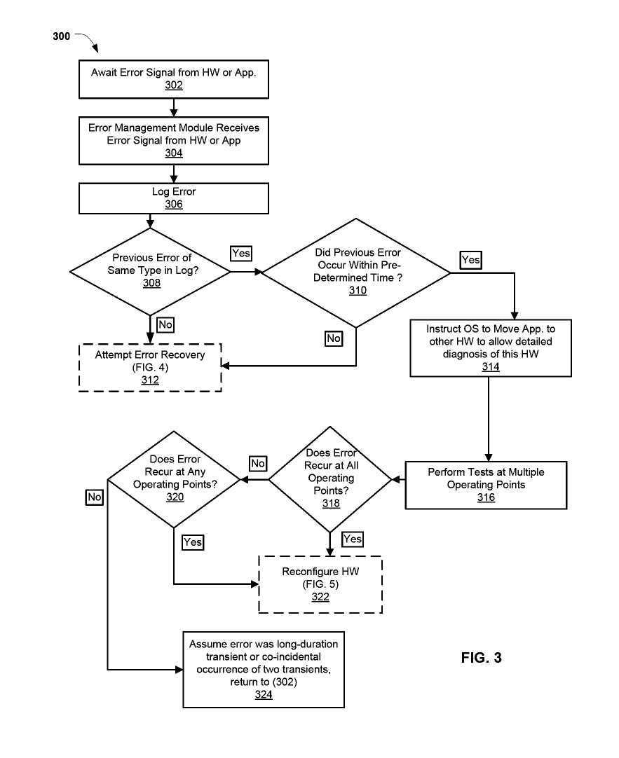

FIG. 3 illustrates a method 300 for detecting and diagnosing hardware errors consistent with one embodiment of the present disclosure. With continued reference to FIG. 1, and with reference numbers of FIG. 1 omitted for clarity, the error management module may await an error signal from the hardware device or application 302. Once the error management module receives an error signal from the hardware device or application 304, the error management module may log the error 306, for example, by logging the type and time of the error into the error log.

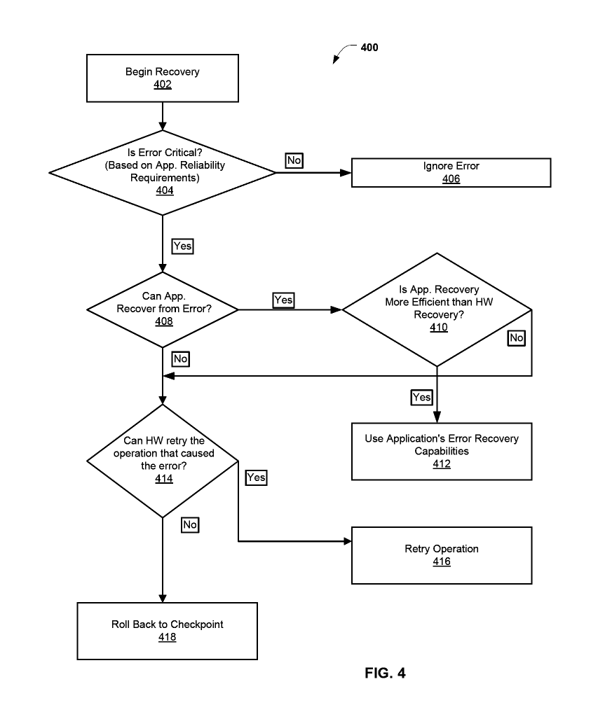

The error management module may determine if the error is eligible for error recovery techniques. For example, the error management module may compare the current error to previous error(s) in the error log to determine if the current error is the same type as a previous error in the error log 308. Here, the “same type” of error may include, for example, an identical error or a similar error in the same class or in the same location in the hardware device. If not the same type of error, the error management module may direct attempts at error recovery 312, as described below in reference to FIG. 4. If the same type of error has occurred, the error management module may determine if the current error and the previous error of the same type have occurred within a predetermined time frame of each other 310. The predetermined time frame can be based on, for example, whether the error is considered critical, whether the error occurs at a specific memory location, the operating environment of the hardware device, etc. If not, the error management module may direct attempts at error recovery 312, as described below in reference to FIG. 4. A positive indication from the operations of 308 and/or 310 may be indicative of a recurring error such as may be caused by aging hardware (e.g., aging of one or more transistors in an integrated circuit), environmental factors, etc., and/or a permanent error in all or part of the hardware device.

If the error has occurred within a predetermined time frame (310), the error management module may perform more detailed diagnosis to determine, for example, if the hardware can be reconfigured to resolve the error or prevent future errors, or if the error is a permanent error that affects the entire hardware device or a part of the hardware device. The error management module may instruct the operating system to move the application/thread(s) to other hardware to allow more detailed diagnosis of the hardware device 314. For example, if the error occurs in one core of a multi-core CPU, the error management module may instruct the OS to move the application running on the core with the error to another core. As another example, if the error occurs at a specified address range in a memory device, the application may be moved to another memory and/or other memory address to permit further diagnosis of the memory device. Regarding the running application and the outstanding error, once the application/thread(s) have moved away from the errant hardware device, the error management module may roll back the application to the last checkpoint before the error occurred and resume operation of the application. If the application/thread(s) cannot be moved away from errant hardware, the error management module may suspend the application and perform more detailed diagnosis (described below), then, if available, roll the application back to the last checkpoint before the error occurred.

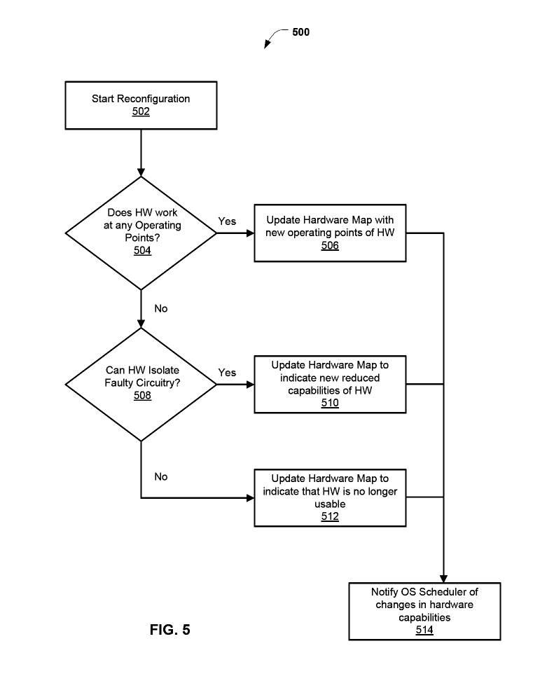

To diagnose the error further, the error management module may perform tests of the hardware device at multiple operating points (if available) 316. For example, the error management module may determine, from the hardware map, if the hardware device is able to be run at more than one operating point (e.g., Vdd, clock rate, etc.). In one embodiment, the error management module may instruct the hardware device to invoke hardware circuitry that enables testing at multiple operating points (e.g., built-in self-test (BIST) circuitry). In another embodiment, the error management module may control the hardware device (via the hardware manager) and execute test routines on the hardware device. For example, the error management module may include a general test routine for the integer ALU and specific test routines for the different components of the ALU (adder, multiplier, etc.). The error management module may then run a sequence of those tests to determine exactly where a fault was, for example, by starting with the general test to see if the ALU operates at all and then running specific test routines to diagnose each component. These tests may be run at different operating points to diagnose timing errors as well as logical errors. Of course, if the application cannot be moved away from the errant hardware device (314), or if tests cannot be run at multiple operating points (316), the error management module may attempt to reconfigure the hardware device 322, as described below in reference to FIG. 5.

If performing tests on the hardware device at multiple operating points is an available option (316), the method may also include determining if the error recurs at all of the operating points 318, and if so the error management module may attempt to reconfigure the hardware device 322, as described below in reference to FIG. 5. If the error does not recur at all operating points, operations may include determining if the error recurs at any operating point 320, and if the error does recur at one or more operating points (but not all of the operating points), the error management module may attempt to reconfigure the hardware device 322, as described below in reference to FIG. 5. If the error does not recur at all the operating points (318) nor does the error recur at any operating point (320), the error management module may assume that the error was a long-duration transient error or a co-incidental occurrence of two (or more) errors and return to the state of awaiting an error signal from the hardware device or application 324.

### Error Recovery

FIG. 4 illustrates a method 400 for error recovery operations consistent with one embodiment of the present disclosure. With continued reference to FIG. 1, and with reference numbers of FIG. 1 omitted for clarity, the error management module may determine that the hardware device or application is able to recover from the error (as described at operation 308 and/or 310 of FIG. 3), and begin the operations of error recovery 402. Error recovery operations may include determining if the error is a critical error 404. As described above, the application may define a certain error or class of errors as critical such that continued operation of the application is, for example, impossible, impractical or would result in unacceptable errors if the application continues without correcting the error. If the error is not critical, the error may be ignored 406, and the hardware device may continue servicing the application. If the error is critical, the error management module may determine if the application can recover from the error 408. As described above, certain applications may include error recovery codes that enable the application to recover from certain types of errors. For example, when an error occurs that cannot be handled in hardware device, such as a double-bit ECC error or a parity fault on a unit with only parity protection, the error management module may select a recovery capability from the set of capabilities provided by the application to correct the error and return to normal operating conditions. This may enable applications that can recover from their own errors, such as applications that are written in a functional style, to recover more efficiently than general applications, which may require more intensive techniques such as checkpointing and rollback.

If the application can recover from the error (408), operations may include determining if using the application to recover from the error is more efficient than using the hardware device to recover from the error 410. Here, the term “efficient” means that, given additional system parameters such as power management budget, bandwidth requirements, etc., application recovery is less demanding on system resources than hardware device recovery techniques. If the application is able to recover from the error, the error management module may instruct the application to utilize the application's error recovery capabilities to recover from the error 412. If the application is unable to recover from the error (408), or if hardware device recovery is more efficient than application recovery (410), operations may include determining if the hardware device can retry the operation that caused the error 414. If retrying the operation is available, the operation may be retried 416. If retrying the errant operation (416) causes another error, the method of FIG. 3 may be invoked to detect and diagnose the new error. If the hardware device cannot retry the operation that caused the error (414), operations may include a roll back to a checkpoint 418.

### Hardware Reconfiguration and System Adaptation

FIG. 5 illustrates a method 500 for hardware device reconfiguration and system adaptation consistent with one embodiment of the present disclosure. With continued reference to FIG. 1, and with reference numbers of FIG. 1 omitted for clarity, the error management module may determine that future errors of the same or similar type may be prevented by reconfiguring the hardware device (as described at operation 318 and/or 320 of FIG. 3), and begin the operations of hardware device reconfiguration 502. Reconfiguration operations may include determining if the hardware device operates as intended (meaning that the hardware device operates without the error) at one or more of the operating points 504. If so, the error management module may select the most effective operating points, and update the hardware map with the new operating points of the hardware device 506. The error management module may also schedule re-testing of the hardware to determine whether the change in allowable operating points is permanent or due to a long-duration transient effect. Thus, for example, if the hardware device remains error free at multiple supply voltage/clock frequency pairs, the error management module may select the highest working supply voltage and clock frequency so that the hardware device runs as fast as possible in light of the error.

If the hardware device does not operate error-free at any operating points (504), the error management module may determine if the hardware can isolate the faulty circuitry 508. For example, if the hardware device is a multi-core CPU and the error is occurring in one of the cores, the hardware device may be configured to isolate only the faulty core while the remaining circuitry of the CPU can be considered valid. As another example, if the hardware device is a multi-core CPU and the error is occurring on the ALU of one of the cores, the faulty ALU may be isolated and marked as unusable, but the remainder of the core that contains the faulty ALU may still be utilized to service an application/thread. As another example, if the hardware device is memory, the faulty portion (e.g., faulty addresses) of the memory may be isolated and marked as unusable, so that data is not written to (or read from) the faulty locations, but the remainder of the memory may still be utilized. If the hardware device can isolate the faulty circuitry (508), operations may also include isolating the defective circuitry and updating the hardware map to indicate the new reduced capabilities of the hardware device 510. If not (508), operations may include updating the hardware map to indicate that the hardware is no longer usable 512. If the hardware map is updated (506, 510 or 512), the error management module may notify the OS task scheduler of the changes in the hardware device. This may enable, for example, the OS task scheduler to make effective assignments of application(s) and/or thread(s) to the hardware device, thus enabling the system to adapt to hardware errors. For example, if the hardware device is listed as having a faulty ALU, the OS task scheduler may utilize this information so that computationally intensive application(s)/thread(s) are not assigned to the core with the faulty ALU.

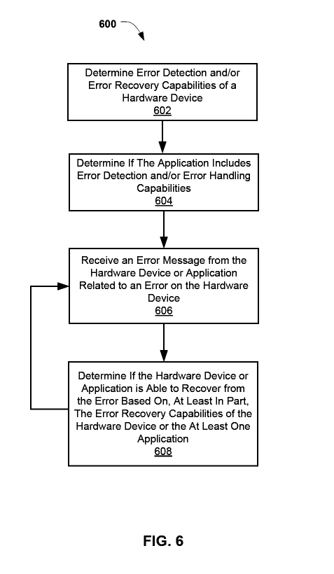

In view of the foregoing description, the present disclosure provides cross-layer error management that determines the error detection and recovery capabilities from both the hardware layer and the application layer. As an error is detected, the error may be diagnosed to determine if the hardware layer or the application layer can recover from the error, based on an efficient or available recovery technique among the recovery techniques provided by the hardware or application. To that end, FIG. 6 illustrates a method 600 for cross-layer error management of a hardware device and at least one application running on the hardware device consistent with one embodiment of the present disclosure. With continued reference to FIG. 1, operations of this embodiment include determining the error detection and/or the error recovery capabilities of a hardware device 602. Operations may also include determining if an application includes error detection and/or error recovery capabilities 604. Operations of this embodiment may further include receiving an error message from the hardware device or the at least one application related to an error on the hardware device 606. Operations may also include determining if the hardware device or the at least one application is able to recover from the error based on, at least in part, the error recovery capabilities of the hardware device or the at least one application 608. Operations 606 and 608 may repeat as additional errors occur.

While FIGS. 2, 3, 4, 5 and 6 illustrate methods according various embodiments, it is to be understood that in any embodiment not all of these operations are necessary. Indeed, it is fully contemplated herein that in other embodiments of the present disclosure, the operations depicted in FIGS. 2, 3, 4, 5 and/or 6 may be combined in a manner not specifically shown in any of the drawings, but still fully consistent with the present disclosure. Thus, claims directed to features and/or operations that are not exactly shown in one drawing are deemed within the scope and content of the present disclosure.

Embodiments described herein may be implemented using hardware, software, and/or firmware, for example, to perform the methods and/or operations described herein. Certain embodiments described herein may be provided as a tangible machine-readable medium storing machine-executable instructions that, if executed by a machine, cause the machine to perform the methods and/or operations described herein. The tangible machine-readable medium may include, but is not limited to, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of tangible media suitable for storing electronic instructions. The machine may include any suitable processing platform, device or system, computing platform, device or system and may be implemented using any suitable combination of hardware and/or software. The instructions may include any suitable type of code and may be implemented using any suitable programming language.

Thus, in one embodiment the present disclosure provides a method for cross-layer error management of a hardware device and at least one application running on the hardware device. The method includes determining, by an error management module, error detection or error recovery capabilities of the hardware device; determining, by the error management module, if the at least one application includes error detection or error recovery capabilities; receiving, by the error management module, an error message from the hardware device or the at least one application related to an error on the hardware device; and determining, by the error management module, if the hardware device or application is able to recover from the error based on, at least in part, the error recovery capabilities of the hardware device and/or the error recovery capabilities of the at least one application.

In another embodiment, the present disclosure provides a system for providing cross-layer error management. The system includes a hardware layer comprising at least one hardware device and an application layer comprising at least one application. The system also includes an error management module configured to exchange commands and data with the hardware layer and the application layer. The error management module is also configured to determine error recovery capabilities of the at least one hardware device; determine if the at least one application includes error recovery capabilities; receive an error message from the at least one hardware device or the at least one application related to an error on the at least one hardware device; and determine if the at least one hardware device or the at least one application is able to recover from the error based on, at least in part, the error recovery capabilities of the at least one hardware device and/or the error recovery capabilities of the at least one application.

In another embodiment, the present disclosure provides a tangible computer-readable medium including instructions stored thereon which, when executed by one or more processors, cause the computer system to perform operations that include determining error recovery capabilities of at least one hardware device; determining if the at least one application includes error recovery capabilities; receiving an error message from the at least one hardware device or the at least one application related to an error on the at least one hardware device; and determining if the at least one hardware device or the at least one application is able to recover from the error based on, at least in part, the error recovery capabilities of the at least one hardware device and/or the error recovery capabilities of the at least one application.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

What is claimed is:

1. A method for cross-layer error management of a hardware device and at least one application running on the hardware device, comprising:
determining, by an error management module, error detection or error recovery capabilities of the hardware device;
determining, by the error management module, if the at least one application includes error detection or error recovery capabilities;
receiving, by the error management module, an error message from the hardware device or the at least one application related to an error on the hardware device;
determining, by the error management module, if the hardware device or application is able to recover from the error based on, at least in part, the error recovery capabilities of the hardware device or the error recovery capabilities of the at least one application.

2. The method of claim 1, further comprising:
generating, by the error management module, an error log that includes a listing of errors by type and time of occurrence; and
logging, by the error management module, the error in the error log;
wherein determining if the hardware device or application is able to recover from the error comprising:
comparing, by the error management module, the error to the error log to determine if an error of the same type as the error is listed in the error log; or
comparing, by the error management module, the error to the error log to determine if an error of the same type as the error has occurred within a predetermined time period.

3. The method of claim 1, further comprising:
determining, by the error management module, reliability requirements of the at least one application, the reliability requirements including a list of critical and non-critical errors;
wherein determining if the hardware device or application is able to recover from the error comprising:
determining, by the error management module, if the error is a critical error based on, at least in part, the reliability requirements of the at least one application.

4. The method of claim 1, further comprising:
determining, by the error management module, power management parameters or usage requirements of the hardware device;
wherein determining if the hardware device or application is able to recover from the error comprising:
selecting, by the error management module, the application recovery capabilities or the hardware device recovery capabilities based on, at least in part, the power management or usage requirements of the hardware device.

5. The method of claim 1, wherein determining if the hardware device or application is able to recover from the error comprising:
determining, by the error management module, if the hardware device is able to retry an operation that caused the error.

6. The method if claim 1, further comprising:
determining, by the error management module, if the hardware device is able to be reconfigured to resolve a future error of the same or similar type as the error by, determining, at least in part, if the hardware device can be run at multiple operating points.

7. The method of claim 6, further comprising:
determining, by the error management module, if the error recurs at all operating points; and/or
determining, by the error management module, if the error recurs at any operating point.

8. The method of claim 6, further comprising:
determining, by the error management module, that the error is resolved by operating the hardware device at least one operating point; and
notifying, by the error management module, an operating system of the at least one operating point of the hardware device that resolves the error.

9. The method of claim 6, further comprising:
determining, by the error management module, if the hardware device can isolate circuitry involved in the error so that the hardware device is able to operate with reduced capabilities; and
notifying, by the error management module, an operating system of the reduced capabilities of the hardware device.

10. The method of claim 1, further comprising:
determining, by the error management module, if the error on the hardware device is a permanent error that renders the hardware device unusable; and
notifying, by the error management module, an operating system that the hardware device is unusable.

11. The method of claim 1, further comprising:
determining, by the error management module, power management parameters or usage requirements of the hardware device; and
disabling, by the error management module, selected error detection or error recovery capabilities of the hardware device based on, at least in part, the power management parameters or usage requirements.

12. A system for providing cross-layer error management, comprising:
a hardware layer comprising at least one hardware device;
an application layer comprising at least one application; and
an error management module configured to exchange commands and data with the hardware layer and the application layer, the error management module is further configured to:
determine error recovery capabilities of the at least one hardware device;
determine if the at least one application includes error detection or error recovery capabilities;
receive an error message from the at least one hardware device or the at least one application related to an error on the at least one hardware device; and
determine if the at least one hardware device or the at least one application is able to recover from the error based on, at least in part, the error recovery capabilities of the at least one hardware device or the error recovery capabilities of the at least one application.

13. The system of claim 12, wherein the error management module is further configured to:
generate an error log that includes a listing of errors by type and time of occurrence;
log the error in the error log;
compare the error to the error log to determine if an error of the same type as the error is listed in the error log; and
compare the error to the error log to determine if an error of the same type as the error has occurred within a predetermined time period.

14. The system of claim 12, wherein the error management module is further configured to:
determine reliability requirements of the at least one application, the reliability requirements including a list of critical and non-critical errors; and
determine if the error is a critical error based on, at least in part, the reliability requirements of the at least one application.

15. The system of claim 12, wherein the error management module is further configured to:
determine power management parameters or usage requirements of the at least one hardware device; and
select the application recovery capabilities or the hardware device recovery capabilities based on, at least in part, the power management or usage requirements of the at least one hardware device.

16. The system of claim 12, wherein the error management module is further configured to:
determine if the at least one hardware device is able to retry an operation that caused the error.

17. The system of claim 12, wherein the error management module is further configured to:
determine if the at least one hardware device is able to be reconfigured to resolve a future error of the same or similar type as the error resolve the error by, determining, at least in part, if the at least one hardware device can be run at multiple operating points.

18. The system of claim 17, wherein the error management module is further configured to:
determine if the error recurs at all operating points; and/or
determine if the error recurs at any operating point.

19. The system of claim 17, wherein the error management module is further configured to:
determine that the error is resolved by operating the at least one hardware device at least one operating point; and
notify an operating system of the at least one operating point of the at least one hardware device that resolves the error.

20. The system of claim 17, wherein the error management module is further configured to:
determine if the at least one hardware device can isolate circuitry involved in the error so that the at least one hardware device is able to operate with reduced capabilities; and
notify an operating system of the reduced capabilities of the at least one hardware device.

21. The system of claim 12, wherein the error management module is further configured to:
determine if the error on the hardware device is a permanent error that renders the hardware device unusable; and
notify an operating system that the hardware device is unusable.

22. The system of claim 12, wherein the error management module is further configured to:
determine power management parameters or usage requirements of the at least one hardware device; and
disable selected error recovery capabilities of the at least one hardware device based on, at least in part, the power management parameters or usage requirements.

23. A tangible computer-readable medium including instructions stored thereon which, when executed by one or more processors, cause the computer system to perform operations comprising:
determining error recovery capabilities of a hardware device;
determining if the at least one application includes error recovery capabilities;
receiving an error message from the hardware device or the at least one application related to an error on the at least one hardware device; and
determining if the hardware device or the at least one application is able to recover from the error based on, at least in part, the error recovery capabilities of the at least one hardware device or the error recovery capabilities of the at least one application.

24. The tangible computer-readable medium of claim 23, wherein the instructions that when executed by one or more of the processors result in the following additional operations comprising:
generating an error log that includes a listing of errors by type and time of occurrence;
logging the error in the error log;
comparing the error to the error log to determine if an error of the same type as the error is listed in the error log; and
comparing the error to the error log to determine if an error of the same type as the error has occurred within a predetermined time period.

25. The tangible computer-readable medium of claim 23, wherein the instructions that when executed by one or more of the processors result in the following additional operations comprising:
determining reliability requirements of the at least one application, the reliability requirements including a list of critical and non-critical errors; and
determining if the error is a critical error based on, at least in part, the reliability requirements of the at least one application.

26. The tangible computer-readable medium of claim 23, wherein the instructions that when executed by one or more of the processors result in the following additional operations comprising:
determining power management parameters or usage requirements of the hardware device; and
selecting the application recovery capabilities or the hardware device recovery capabilities based on, at least in part, the power management or usage requirements of the hardware device.

27. The tangible computer-readable medium of claim 23, wherein the instructions that when executed by one or more of the processors result in the following additional operation comprising:
determining if the hardware device is able to retry an operation that caused the error.

28. The tangible computer-readable medium of claim 23, wherein the instructions that when executed by one or more of the processors result in the following additional operations comprising:
determining if the hardware device is able to be reconfigured to resolve a future error of the same or similar type as the error by, determining, at least in part, if the at least one hardware device can be run at multiple operating points.

29. The tangible computer-readable medium of claim 28, wherein the instructions that when executed by one or more of the processors result in the following additional operations comprising:
determining if the error recurs at all operating points; and/or
determining if the error recurs at any operating point.

30. The tangible computer-readable medium of claim 28, wherein the instructions that when executed by one or more of the processors result in the following additional operations comprising:
determining that the error is resolved by operating the at least one hardware device at least one operating point; and
notifying an operating system of the at least one operating point of the at least one hardware device that resolves the error.

31. The tangible computer-readable medium of claim 28, wherein the instructions that when executed by one or more of the processors result in the following additional operations comprising:
determining if the at least one hardware device can isolate circuitry involved in the error so that the at least one hardware device is able to operate with reduced capabilities; and
notifying an operating system of the reduced capabilities of the at least one hardware device.

32. The tangible computer-readable medium of claim 23, wherein the instructions that when executed by one or more of the processors result in the following additional operations comprising:
determining if the error on the hardware device is a permanent error that renders the hardware device unusable; and
notifying an operating system that the hardware device is unusable.

33. The tangible computer-readable medium of claim 23, wherein the instructions that when executed by one or more of the processors result in the following additional operations comprising:
determining power management parameters or usage requirements of the at least one hardware device; and
disabling selected error recovery capabilities of the at least one hardware device based on, at least in part, the power management parameters or usage requirements.
